(19) United States
(12) Patent Application Publication
(10) Pub. No.: US 2006/0232189 A1
(43) Pub. Date: Oct. 19, 2006

(54) Electron emission device and method for manufacturing the same

(76) Inventors: Kyung-Sun Ryu, Suwon-si (KR); Cheol-Hyeon Chang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/349,952

(22) Filed: Feb. 9, 2006

(30) Foreign Application Priority Data
Feb. 28, 2005 (KR) 10-2005-0016842

(51) Int. Cl. H01J 1/62

(52) U.S. Cl. 313/497

(57) ABSTRACT

An electron emission device includes first and second substrates separated by a predetermined distance, electron emission regions on the first substrate, driving electrodes on the first substrate, a focusing electrode over the driving electrodes and insulated from the driving electrodes, and a plurality of spacers disposed between the first and the second substrates, each spacer having a conductive film on an outer surface. The conductive film is electrically connected to the focusing electrode.

### BACKGROUND OF THE INVENTION

1. Field of the Invention

The present invention relates to an electron emission device. In particular, the present invention relates to an electron emission device including a support structure of spacers, which may help reduce or prevent electron beams from being distorted due to the charging of spacers, and a method of manufacturing the electron emission device.

2. Description of Related Art

Generally, electron emission devices are classified into those using hot cathodes as the electron emission source, and those using cold cathodes as the electron emission source. There are several types of cold cathode electron emission devices. including a field emitter array (FEA) type, a metal-insulator-metal (MIM) type, a metal-insulator-semiconductor (MIS) type and a surface conduction emitter (SCE) type.

The MIM type and the MIS type electron emission devices have electron emission regions with a metal/insulator/metal (MIM) structure and a metal/insulator/semiconductor (MIS) structure, respectively. When voltages are applied to the two metals, or the metal and the semiconductor, on either side of the insulator, electrons migrate from the high electric potential metal or semiconductor to the low electric potential metal, where the electrons are accumulated and emitted.

The SCE type electron emission device includes a thin conductive film formed between first and second electrodes arranged facing each other on a substrate. High resistance electron emission regions or micro-crack electron emission regions are positioned on the thin conductive film. When voltages are applied to the first and second electrodes and an electric current is applied to the surface of the conductive film, electrons are emitted from the electron emission regions.

The FEA type electron emission device uses electron emission regions made from materials having low work functions or high aspect ratios. When exposed to an electric field in a vacuum atmosphere, electrons are easily emitted from these electron emission regions. Electron emission regions having sharp front tip structure based on molybdenum (Mo) or silicon (Si) have been used. Also, electron emission regions including carbonaceous materials, such as carbon nanotubes, have been used.

Although the different types of electron emission devices have specific structures, they basically have first and second substrates sealed to each other to form a vacuum vessel, electron emission regions formed on the first substrate, driving electrodes for controlling the emission of electrons from the electron emission regions, phosphor layers formed on a surface of the second substrate facing the first substrate, and an anode electrode for accelerating the electrons emitted from the electron emission regions toward the phosphor layers, thereby causing light emission to generate the display.

Electron emission devices may include spacers arranged between the first and the second substrates. The spacers may support the vacuum vessel to prevent it from being distorted and broken and maintain a constant distance between the first and the second substrates. The spacers may be located corresponding to non-light emission regions disposed between the respective phosphor layers. That is, the spacers may correspond to black layers, such that they do not occupy the area of the phosphor layers.

The typical trajectories of electron beams during the operation of the electron emission device is such that some of the electrons emitted from the electron emission regions do not travel straight toward the phosphor layers at the relevant pixels, but instead are diffused toward the black layers or the phosphor layers at incorrect pixels neighboring the target pixels. Accordingly, electrons may collide with the surface of the spacers. The collision of electrons with the spacers may result in the spacers becoming surface-charged with a positive potential, or a negative potential, depending upon the material. Charged spacers may distort the trajectories of the electron beams. Accordingly, in an electron emission device having surface-charged spacers, the display uniformity around the spacers may deteriorate, e.g., by causing unintended light emission from phosphor layers, thereby deteriorating the overall screen image quality.

### SUMMARY OF THE INVENTION

The present invention is therefore directed to an electron emission device that inhibits charging of spacers to prevent distortion in the routes of electron beams and deterioration in the screen image quality and a method of manufacturing the electron emission device.

It is therefore a feature of an embodiment of the present invention to provide an electron emission device including spacers having a conductive film on an outer surface that is electrically connected to a focusing electrode.

It is therefore another feature of an embodiment of the present invention to provide an electron emission device having spacer loading portions for receiving the spacers.

It is therefore a further feature of an embodiment of the present invention to provide an electron emission device having spacer loading portions wherein the focusing electrode covers the bottom and sides of the spacer loading portions.

At least one of the above and other features and advantages of the present invention may be realized by providing an electron emission device that may include first and second substrates separated by a predetermined distance, electron emission regions on the first substrate, driving electrodes on the first substrate to control the emission of electrons from the electron emission regions, a focusing electrode on the driving electrodes and insulated from the driving electrodes, the focusing electrode having openings to pass the electron beams, and a plurality of spacers disposed between the first and the second substrates, each spacer having a conductive film on an outer surface, the conducive film being electrically connected to the focusing electrode.

The electron emission device may include spacer loading portions in the focusing electrode and the insulating layer, the spacer loading portions receiving the bottom end portions of the spacers. The electron emission device may include a conductive adhesive layer in each spacer loading portion to electrically connect the conductive film of the spacer with the focusing electrode and the spacer loading portions may penetrate the insulating layer. The spacer loading portions may be located corresponding to the locations between the driving electrodes and the focusing electrode may be on lateral and bottom surfaces of the spacer loading portion.

At least one of the above and other features and advantages of the present invention may also be realized by providing a display including first and second substrates separated by a predetermined distance, an electron emission unit on the first substrate, the electron emission unit including electron emission regions, first and second electrodes for controlling the emission of electrons from the electron emission regions by receiving a scan signal voltage and a data signal voltage, a third electrode for controlling the routes of electrons emitted from the electron emission regions by receiving a direct voltage, and an insulating layer under the third electrode, a light emission unit on a surface of the second substrate facing the first substrate, and a plurality of spacers arranged between the first and the second substrates, each spacer having a conductive film on an outer surface, the conductive film being electrically connected to the third electrode.

The display may include spacer loading portions in the third electrode and the insulating layer, the spacer loading portions receiving bottom end portions of the spacers. The display may include a conductive adhesive layer in each spacer loading portion to electrically connect the conductive film of the spacer with the third electrode. The spacer loading portions may penetrate the insulating layer. The third electrode may be on lateral and bottom surfaces of the spacer loading portion.

At least one of the above and other features and advantages of the present invention may further be realized by providing a method of manufacturing an electron emission device, including providing a first substrate having driving electrodes and an insulating layer, forming a focusing electrode on the insulating layer, providing a conductive film on an outer surface of spacers for electrically coupling a plurality of spacers to the focusing electrode, and attaching a second substrate to the first substrate, the plurality of spacers interposed between the first and second substrates.

The method may include, after forming the focusing electrode, forming spacer loading portions in the insulating layer and the focusing electrode. Forming the spacer loading portions may include removing portions of the focusing electrode and the insulating layer to simultaneously form the spacer loading portions and openings for passing electron beams.

The method may also include applying a conductive paste containing a photosensitive material on the first substrate and in the spacer loading portions, selectively hardening the conductive paste in the spacer loading portions by illuminating ultraviolet rays onto the spacer loading portions from a rear side of the first substrate, and fitting the spacers into the spacer loading portions such that the conductive paste electrically connects a conductive film of the spacers to the focusing electrode. The method may further include forming spacer loading portions in the insulating layer and subsequently forming the focusing electrode on the insulating layer, wherein forming the focusing electrode includes forming a conductive layer on a bottom and a lateral surface of the spacer loading portions, and may include, after forming the conductive layer, filling the spacer loading portions with a conductive paste. The method may further include, after filling the spacer loading portions with a conductive paste, fitting the spacers into the spacer loading portions such that the spacers are electrically connected to the focusing electrode.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partial exploded perspective view of an electron emission device according to a first embodiment of the present invention.

FIG. 2 illustrates a partial sectional view of FIG. 1, taken along the I-I line.

FIG. 3 illustrates a partial sectional view of FIG. 1, taken along the II-II line.

FIG. 4 illustrates a partial sectional view of an electron emission device according to a second embodiment of the present invention.

FIG. 5 illustrates a partial sectional view of a light emission unit for an electron emission device according to a third embodiment of the present invention.

FIGS. 6 to 8 illustrate perspective views of spacers according to different embodiments of a spacer of the present invention.

FIG. 9 illustrates a partial sectional view of a spacer loading portion for an electron emission device according to a fourth embodiment of the present invention.

FIGS. 10A to 10D illustrate stages in a method of manufacturing an electron emission device according to the first embodiment of the present invention.

FIGS. 11A to 11C illustrate stages in a method of manufacturing an electron emission device according to the fourth embodiment of the present invention.

### DETAILED DESCRIPTION OF THE INVENTION

Korean Patent Application No. 10-2005-0016842, filed on Feb. 28, 2005, in the Korean Intellectual Property Office, and entitled: “Electron Emission Device and Method for Manufacturing the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

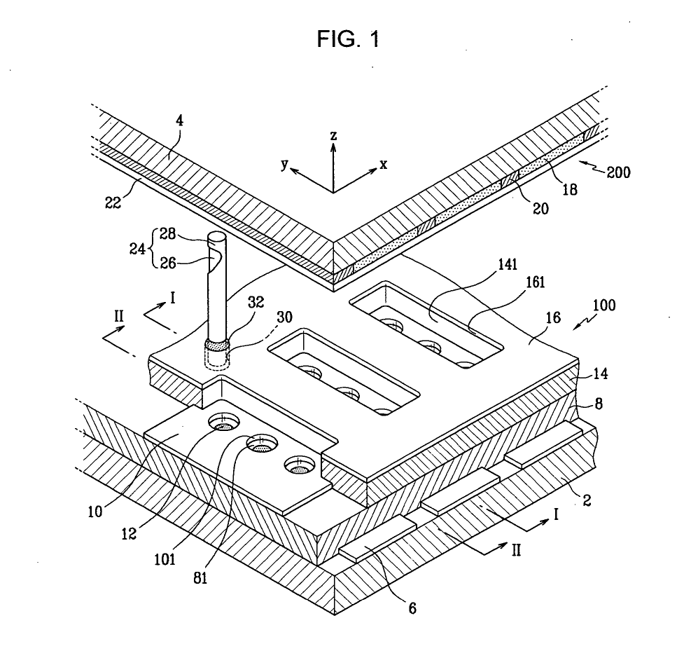

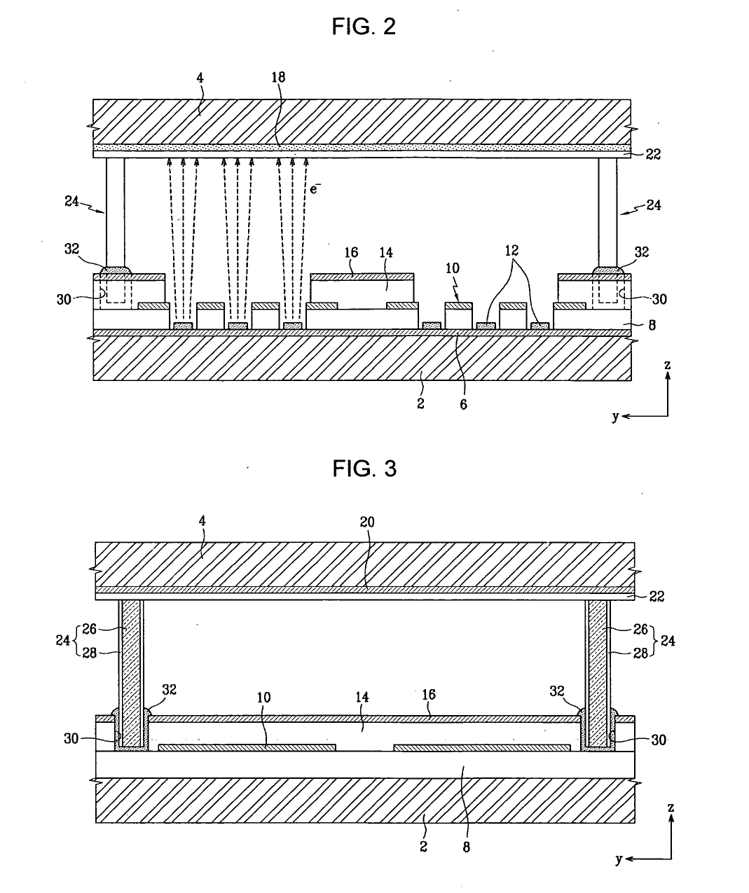

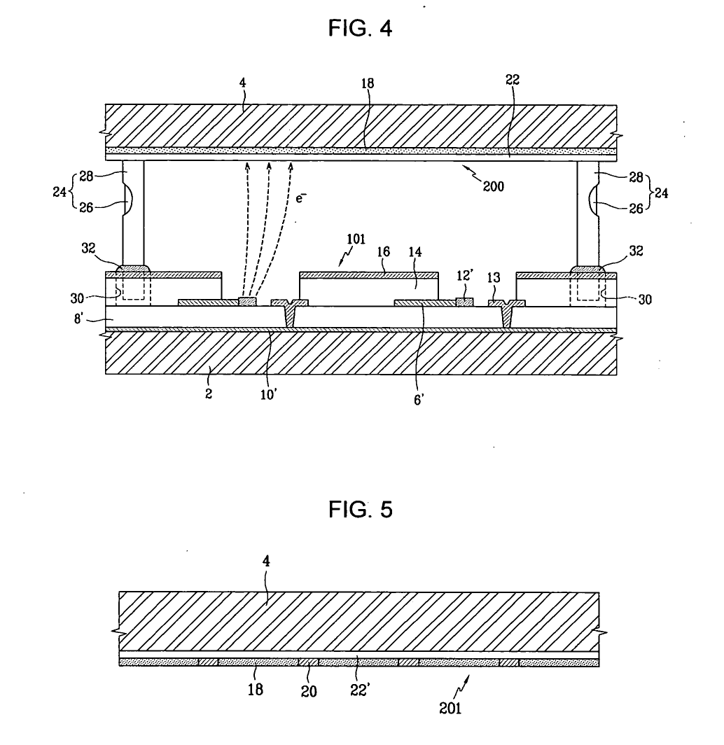

As illustrated in FIGS. 1 to 3, an electron emission device according to the present invention may include a first substrate 2 and a second substrate 4 arranged parallel to each other and separated by a predetermined distance. A sealing member (not shown) may be provided at the peripheries of the first substrate 2 and the second substrate 4 to form an evacuated inner space between the two substrates.

An electron emission unit 100 may be provided on a surface of the first substrate 2 facing the second substrate 4 to emit electrons toward the second substrate 4. A light emission unit 200 may be provided on a surface of the second substrate 4 facing the first substrate 2 to emit visible rays upon excitement by electrons, the light emission generating a display.

With the electron emission unit 100, cathode electrodes 6 may be formed in a striped pattern on the first substrate 2, in a direction parallel to the first substrate 2. A first insulating layer 8 may be formed on the entire surface of the first substrate 2 and covering the cathode electrodes 6. Gate electrodes 10 may be formed in a striped pattern on the first insulating layer 8 and may be perpendicular to the cathode electrodes 6. The crossed regions of the cathode electrodes 6 and the gate electrodes 10 may be defined as pixel regions.

Electron emission regions 12 may be formed on the cathode electrodes 6 at the respective pixel regions. Openings 81 and 101 may be formed at the first insulating layer 8 and the gate electrodes 10, respectively, corresponding to the electron emission regions 12 and exposing the electron emission regions 12 on the first substrate 2. Note that the illustrated configuration is merely exemplary, and the planar shape, number per pixel and arrangement of the electron emission regions 12 are not limited to the illustrated configuration, and may be suitably altered in various manners.

The electron emission regions 12 may be formed with a material emitting electrons under the application of an electric field, e.g., a carbonaceous material, a nanometer-sized material, etc. The electron emission regions 12 may be formed with, e.g., carbon nanotube, graphite, graphite nanofiber, diamond, diamond-like carbon, C60, silicon nanowire, etc., or a combination thereof, and may be formed by screen-printing, direct growth, chemical vapor deposition, sputtering, etc.

As the driving electrodes, the cathode electrodes 6 and the gate electrodes 10 may control the turning on or off of the respective pixels and the amount of electron emission. That is, a scanning signal voltage may be applied to one of the cathode electrodes 6 and the gate electrodes 10, and a data signal voltage may be applied to the other electrode. The data signal may exhibit a voltage difference from the scanning signal voltage in the range of several volts to several tens of volts. Accordingly, electric fields may be formed around the electron emission regions 12 at the pixels where the voltage difference between the cathode electrodes 6 and the gate electrodes 10 exceeds a threshold value, and electrons may thus be emitted from the electron emission regions 12.

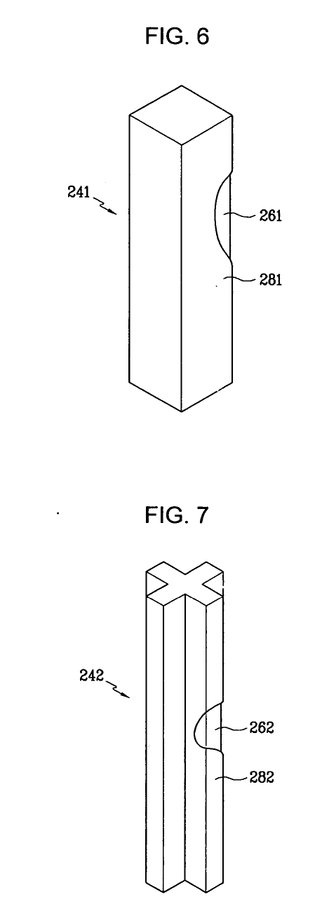

Note that, alternatively, the cathode electrodes and the gate electrodes may be swapped, as illustrated by cathode electrodes 6′ and gate electrodes 10′ in FIG. 4. In the electron emission unit 101, the cathode electrodes 6′ may be placed over the gate electrodes 10′, with an insulating layer 8′ interposed therebetween. Electron emission regions 12′ may be formed on the insulating layer 8′ and may contact the lateral sides of the cathode electrodes 6. Counter electrodes 13 may be electrically connected to the gate electrodes 10′ and may be spaced apart from the electron emission regions 12′ between the cathode electrodes 6′. The counter electrodes 13 may serve to pull the electric fields of the gate electrodes 10′ over the first insulating layer 8′ such that strong electric fields are formed around the electron emission regions 12′.

Returning to the devices illustrated in FIGS. 1 to 3, a second insulating layer 14 and a focusing electrode 16 may be formed on the gate electrodes 10 and the first insulating layer 8. Openings 141 and 161 may be formed at the second insulating layer 14 and the focusing electrodes 16, respectively, to allow electron beams to pass. The focusing electrodes 16 may serve to control the routes of the electron beams, and may receive a negative direct current voltage in the range of several volts to several tens of volts, thereby generating a repulsive force to electrons passing through the openings 161 and focusing electrons passing through the openings 161. The openings 141 and 161 of the second insulating layer 14 and the focusing electrode 16 may correspond to the respective pixel regions, one by one. In this case, the focusing electrode 16 may collectively focus electrons emitted from one pixel region.

Phosphor layers 18 may be formed on a surface of the second substrate 4 facing the first substrate 2 together with black layers 20, which may be disposed between the respective phosphor layers 18 to enhance the contrast of the screen. An anode electrode 22 may be formed on the phosphor layers 18 and the black layers 20 using, e.g., a metallic material such as aluminum. As illustrated in FIGS. 1 to 3, the phosphor layers 18 may be formed in a striped pattern and may correspond to the cathode electrodes 6. The black layers 20 may be formed in a striped pattern between the phosphor layers 18.

The anode electrode 22 may receive a positive direct current voltage in the range of several hundreds of volts to several thousands of volts for accelerating the electron beams, and may serve to reflect visible rays, radiated from the phosphor layers 18 toward the first substrate 2, back toward the second substrate 4, thereby heightening the luminance of the screen.

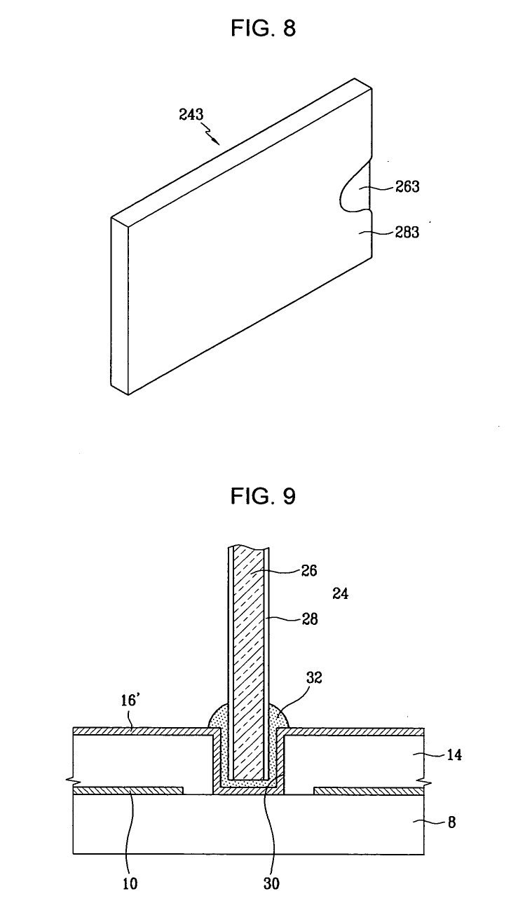

Alternatively, as illustrated in FIG. 5, an anode electrode 22′ may first be formed on a surface of the second substrate 4, and phosphor layers 18 and black layers 20 may be formed on the anode electrode 22′. In this case, the anode electrode 22′ may be formed with a transparent conductive material, e.g., indium tin oxide (ITO), such that it can transmit the visible rays radiated from the phosphor layers 18. Reference numeral 201 of FIG. 5 indicates a light emission unit.

Returning to the devices illustrated in FIGS. 1 to 3, a plurality of spacers 24 may be disposed between the first substrate 2 and the second substrate 4 to maintain a constant distance between them. The spacers 24 may be located corresponding to the black layers 20, so as not to occupy the area of the phosphor layers 18.

In this embodiment, the spacer 24 may be formed with a main body 26 and a conductive film 28 formed on a surface of the main body 26 and having a predetermined thickness. The main body 26 may be formed by, e.g., mechanically processing glass or ceramic, partially crystallizing a photosensitive glass and removing the crystallized portions through etching, or other suitable processes.

A spacer loading portion 30 may be formed to fit the spacer 24 therein. In particular, the spacer loading portion 30 may be formed at the focusing electrode 16 and the second insulating layer 14 to fit the bottom end portion of the spacer 24 therein. The spacer loading portion 30 may penetrate the second insulating layer 14, and may be disposed between the gate electrodes 10 on the first insulating layer to prevent the focusing electrodes 16 and the gate electrodes 10 from being electrically connected to each other by a later-formed conductive adhesive layer 32.

The spacer loading portion 30 may have a width larger than a width of the spacer 24 by a predetermined margin, and may receive the bottom end portion of the spacer 24 therein. A conductive adhesive layer 32 may be internally formed at the spacer loading portion 30. The conductive adhesive layer 32 may attach the spacer 24 to the first substrate 2, and may electrically connect the focusing electrode 16 with the conductive film 28 of the spacer 24.

The spacer 24 may be partially fitted into the spacer loading portion 30 such that it is rigidly fixed to the first substrate 2. The bottom end portion of the spacer 24, fitted into the spacer loading portion 30, may be surrounded by the conductive adhesive layer 32, the contact resistance between the spacer 24 and the focusing electrode 16 may be reduced.

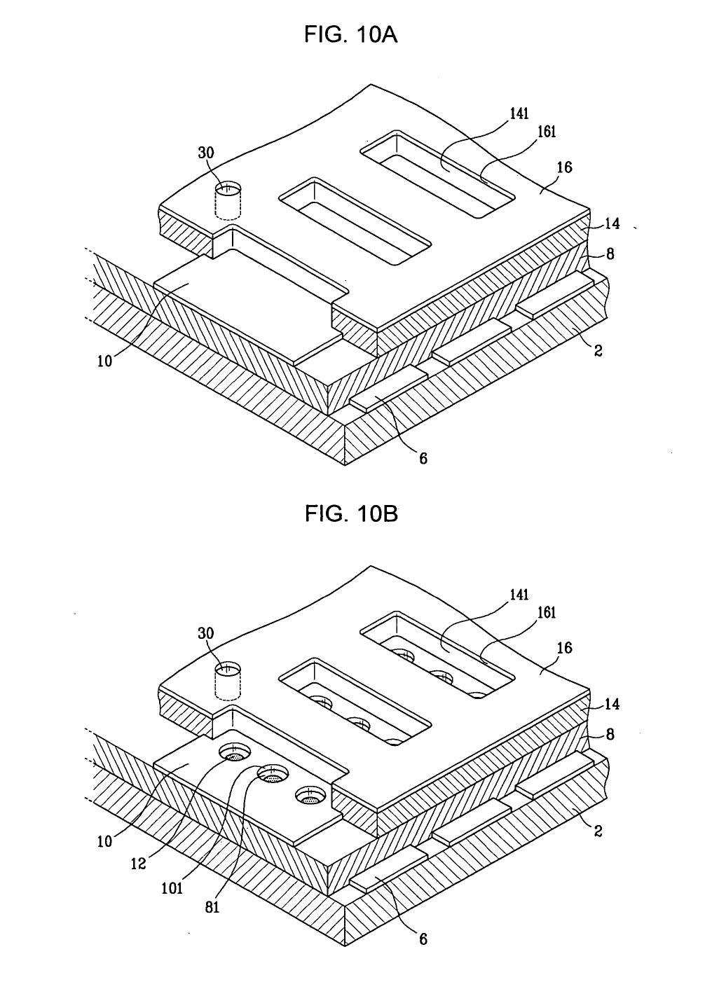

As illustrated in FIG. 1, the spacer 24 may be cylindrical in shape. However, the present invention is not limited to this shape. Thus, the shape of the spacer may be varied. See, e.g., a rectangular pillar-shaped spacer 241 illustrated in FIG. 6, a cross pillar-shaped spacer 242 illustrated in FIG. 7, a wall-shaped spacer 243 illustrated in FIG. 8, etc. The reference numerals 261, 262 and 263 of FIGS. 6 to 8 indicate a main body of the spacer, and the reference numerals 281, 282 and 283 thereof indicate a conductive film.

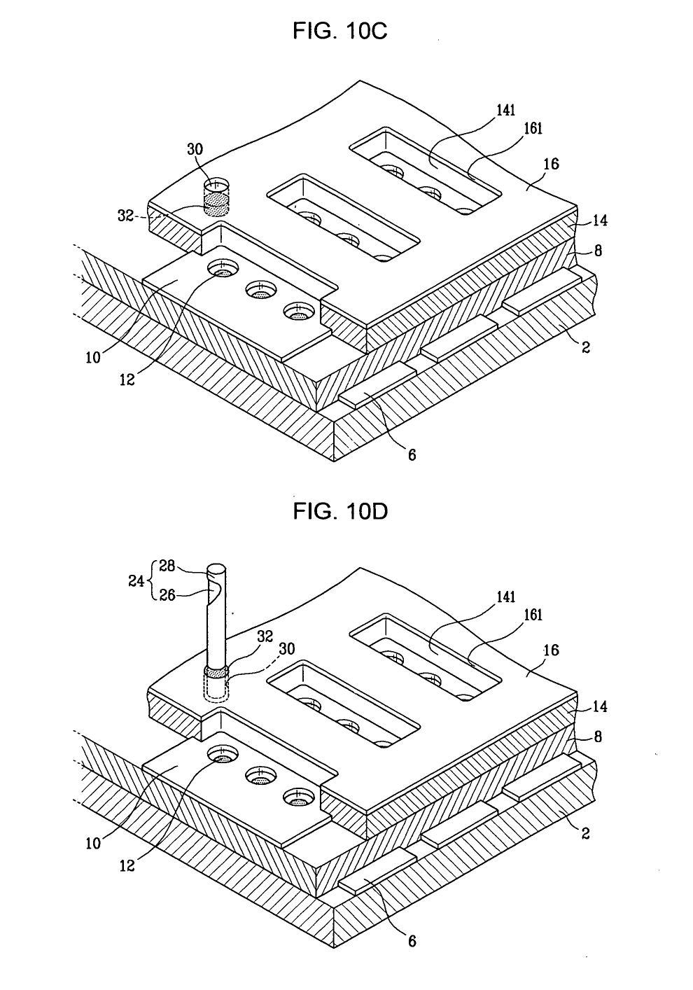

In a fourth embodiment, as illustrated in FIG. 9, a focusing electrode 16′ may be formed on an inner surface of the spacer loading portion 30 and the second insulating layer 14. That is, in this embodiment, the focusing electrode 16′ may be formed on the bottom surface of the spacer loading portion 30 as well as on the lateral surface thereof. In this case, the contact resistance between the conductive film 28 of the spacer 24 and the focusing electrode 16 may be further reduced to improve the electrical connection between the conductive film 28 and the focusing electrode 16′.

According to electron emission devices of the present invention, electrons may be emitted from the electron emission regions 12 due to a voltage difference between the cathode electrodes 6 and the gate electrodes 10. The emitted electrons may be attracted by a high voltage applied to the anode electrode 22. The emitted electrons may collide against the phosphor layers 18 at the relevant pixels to induce light emission therefrom to produce a display. In this process, some of the electrons emitted from the electron emission regions 12 may not travel straight toward the phosphor layers 18 at the corresponding pixels, even in view of the focusing operation of the focusing electrode 16. Thus, some electrons may diffuse and collide against the spacers 24. Electrons colliding against the spacers 24 may be conducted to the focusing electrode 16 via the conductive film 28 of the spacer 24 and via the conductive adhesive layer 32. Thus, during the operation of an electron emission device according to the present invention, the possibility of developing a surface charge on the spacers 24 may be reduced or eliminated.

In an electron emission device according to embodiments of the present invention, the spacers 24, 241, 242 and 243 may be prevented from being charged, so that distortion of electron beams around the spacers 24, 241, 242 and 243 is reduced or eliminated. As a result, the visibility and display uniformity around the spacers 24, 241, 242 and 243 may be enhanced.

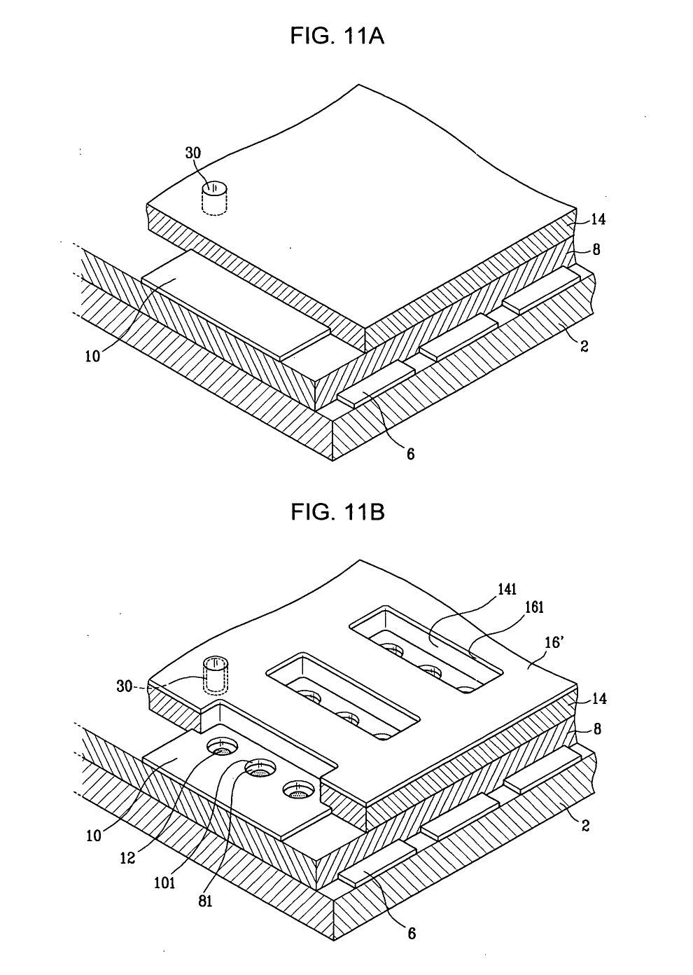

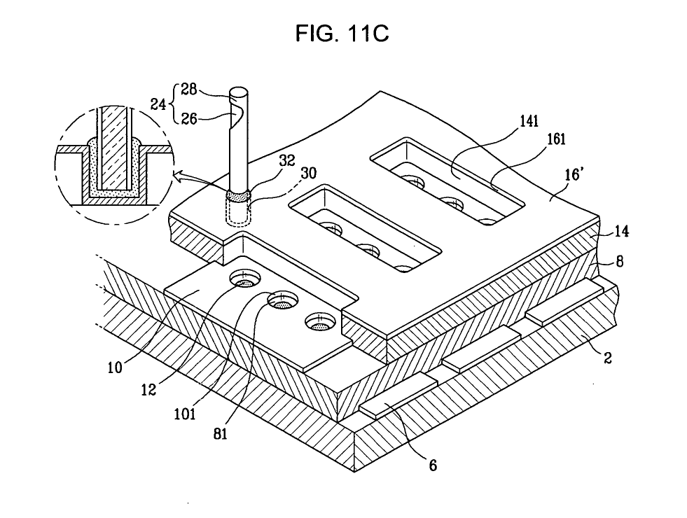

A method of manufacturing an electron emission device according to the present invention will be now explained. The following explanation will detail the process of forming a spacer loading portion 30 and coating a conductive adhesive layer 32. A method of manufacturing the electron emission device according to the first embodiment of the present invention will be explained with reference to FIGS. 10A to 10D, and a method of manufacturing the electron emission device according to the fourth embodiment of the present invention will be explained with reference to FIGS. 11A to 11C.

As illustrated in FIG. 10A, a method of manufacturing the electron emission device according to the first embodiment of the present invention may include sequentially forming the cathode electrodes 6, the first insulating layer 8 and the gate electrode 10 on the first substrate 2. The second insulating layer 14 and the focusing electrode 16 may be formed on the gate electrodes 10 and the first insulating layer 8. The first insulating layer 8 may be formed with a transparent material.

Portions of the focusing electrode 16 and the second insulating layer 14 at the crossed regions of the cathode electrodes 6 and the gate electrodes 10 may have openings 161 and 141 formed respectively therein by, e.g., etching, to partially expose the gate electrodes 10. Portions of the focusing electrode 16 and the second insulating layer 14 disposed between the gate electrodes 10 may have spacer loading portions 30 formed therein, e.g., by the etching process used to form openings 161 and 141.

As illustrated in FIG. 10B, the gate electrodes 10 and the underlying insulating layer 8 may have openings 101 and 81 formed therein by, e.g., etching, to partially expose the cathode electrodes 6. The electron emission regions 12 may be formed on the cathode electrodes 6 within the openings 101 and 81. The cathode electrodes 6 may be formed with a transparent conductive material.

In order to form the electron emission regions 12, a paste-phase mixture containing an electron emission material and a photosensitive material may be coated onto the entire surface of the first substrate 2, and an exposure mask (not shown) may be placed at the rear, or opposite side, of the first substrate 2. Ultraviolet rays may be illuminated onto the mixture from the rear side of the first substrate 2, through the transparent conductive cathode electrodes 6, to partially harden the mixture, and any non-hardened mixture may be removed through developing. The remaining mixture may be dried and fired.

As illustrated in FIG. 10C, the spacer loading portions 30 may be filled with a conductive paste to form a conductive adhesive layer 32. The conductive adhesive layer 32 may be formed through, e.g., preparing a conductive paste containing a photosensitive material, applying the conductive paste onto the entire surface of the first substrate 2, placing an exposure mask (not shown) at the rear of the first substrate and illuminating ultraviolet rays onto the conductive paste filled within the spacer loading portions 30 from the rear side of the first substrate 2 to selectively harden it, and removing the non-hardened conductive paste through developing. Accordingly, the conductive adhesive layer 32 may be precisely formed only within the spacer loading portions 30. The spacer loading portions 30 may be partially filled with the conductive adhesive layer 32.

As illustrated in FIG. 10D, spacers 24, each having a main body 26 and a conductive film 28, may be prepared. The conductive adhesive layer 32 may be softened by, e.g., melting, and the spacers 24 may be fitted into the spacer loading portions 30. The conductive adhesive layer 32 may then be dried. The spacers 24 may thus be rigidly fixed to the first substrate 2 such that the bottom end portions of the spacers 24 are fitted into the spacer loading portions 30. The conductive films 28 of the respective spacers 24 may be electrically connected to the focusing electrode 16 via the adhesive layer 32.

With reference to FIG. 1, a second substrate 4 having a light emission unit 200 may be prepared, and a sealing member (not shown) may be applied to the periphery of the first substrate 2 or the second substrate 4. The first and the second substrates 2 and 4 may be aligned to each other and the sealing member may be fired to seal the first substrate 2 and the second substrate 4 to each other. The inner space between the first substrate 2 and the second substrate 4 may be exhausted to a vacuum to thereby complete an electron emission device according to the present invention.

A method of manufacturing the electron emission device according to the fourth embodiment of the present invention will be now explained. As illustrated in FIG. 11A, the cathode electrodes 6, the first insulating layer 8 and the gate electrodes 10 may be sequentially formed on the first substrate 2, and the second insulating layer 14 may be formed on the gate electrodes 10 and the first insulating layer 8. The portions of the second insulating layer 14 disposed between the gate electrodes 10 may have spacer loading portions 30 formed therein by, e.g., etching.

Thereafter, as illustrated in FIG. 11B, a conductive material may be coated onto the second insulating layer 14 to form a focusing electrode 16′. The focusing electrode 16′ may be disposed on the bottom surface of the spacer loading portion 30 as well as on the lateral surface thereof.

Portions of the focusing electrode 16′ and the second insulating layer 14 corresponding to the crossed regions of the cathode electrodes 6 and the gate electrodes 10 may have the openings 161 and 141 formed therein, e.g., by etching, to partially expose the gate electrodes 10. The gate electrodes 10 and the underlying first insulating layer 8 may have the openings 101 and 81 formed respectively therein, e.g., by etching, to partially expose the cathode electrodes 6. The electron emission regions 12 may be formed on the cathode electrodes 6 within the openings 101 and 81.

As illustrated in FIG. 11C, the spacer loading portions 30 may be filled with a conductive paste to form a conductive adhesive layer 32. The spacers 24, each with a main body 26 and a conductive film 28, may be prepared and fitted into the spacer loading portions 30. The alignment and sealing of the first substrate 2 and the second substrate 4 may be performed as described above.

Embodiments of the present invention have been illustrated and explained in the context of FEA type electron emission device, where the electron emission regions are formed with a material emitting electrons under the application of an electric field. However, the present invention is not limited to FEA type electron emission devices and may be similarly applied to other types of electron emission devices.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission device, comprising:
first and second substrates separated by a predetermined distance;
electron emission regions on the first substrate;
driving electrodes on the first substrate to control the emission of electrons from the electron emission regions;
a focusing electrode on the driving electrodes and insulated from the driving electrode, the focusing electrode having openings to pass the electron beams; and
a plurality of spacers disposed between the first and the second substrates, each spacer having a conductive film on an outer surface, wherein the conductive film is electrically connected to the focusing electrode.

2. The electron emission device as claimed in claim 1, further comprising spacer loading portions in the focusing electrode and the insulating layer, the spacer loading portions receiving the bottom end portions of the spacers.

3. The electron emission device as claimed in claim 2, further comprising a conductive adhesive layer in each spacer loading portion to electrically connect the conductive film of the spacer with the focusing electrode.

4. The electron emission device as claimed in claim 2, wherein the spacer loading portions penetrate the insulating layer.

5. The electron emission device as claimed in claim 4, wherein the spacer loading portions are located corresponding to the locations between the driving electrodes.

6. The electron emission device as claimed in claim 2, wherein the focusing electrode is on lateral and bottom surfaces of the spacer loading portion.

7. A display comprising:
first and second substrates separated by a predetermined distance;
an electron emission unit on the first substrate, the electron emission unit comprising:
electron emission regions;
first and second electrodes for controlling the emission of electrons from the electron emission regions by receiving a scan signal voltage and a data signal voltage;
a third electrode for controlling the routes of electrons emitted from the electron emission regions by receiving a direct voltage; and
an insulating layer under the third electrode;
a light emission unit on a surface of the second substrate facing the first substrate; and
a plurality of spacers arranged between the first and the second substrates, each spacer having a conductive film on an outer surface, wherein the conductive film is electrically connected to the third electrode.

8. The display as claimed in claim 7, further comprising spacer loading portions in the third electrode and the insulating layer, the spacer loading portions receiving bottom end portions of the spacers.

9. The display as claimed in claim 8, further comprising a conductive adhesive layer in each spacer loading portion to electrically connect the conductive film of the spacer with the third electrode.

10. The display as claimed in claim 8, wherein the spacer loading portions penetrate the insulating layer.

11. The display as claimed in claim 8, wherein the third electrode is on lateral and bottom surfaces of the spacer loading portion.

12. A method of manufacturing an electron emission device, comprising:
providing a first substrate having driving electrodes and an insulating layer;
forming a focusing electrode on the insulating layer;
providing a conductive film on an outer surface of spacers for electrically coupling spacers to the focusing electrode; and
attaching a second substrate to the first substrate, the spacers interposed between the first and second substrates.

13. The method of manufacturing an electron emission device as claimed in claim 12, further comprising, after forming the focusing electrode, forming spacer loading portions in the insulating layer and the focusing electrode.

14. The method of manufacturing an electron emission device as claimed in claim 13, wherein forming the spacer loading portions comprises removing portions of the focusing electrode and the insulating layer to simultaneously form the spacer loading portions and openings for passing electron beams.

15. The method of manufacturing an electron emission device as claimed in claim 14, further comprising:
applying a conductive paste containing a photosensitive material on the first substrate and in the spacer loading portions;
selectively hardening the conductive paste in the spacer loading portions by illuminating ultraviolet rays onto the spacer loading portions from a rear side of the first substrate; and
fitting the spacers into the spacer loading portions such that the conductive paste electrically connects a conductive film of the spacers to the focusing electrode.

16. The method of manufacturing an electron emission device as claimed in claim 12, further comprising forming spacer loading portions in the insulating layer and subsequently forming the focusing electrode on the insulating layer, wherein forming the focusing electrode includes forming a conductive layer on a bottom and a lateral surface of the spacer loading portions.

17. The method of manufacturing an electron emission device as claimed in claim 16, further comprising, after forming the conductive layer, filling the spacer loading portions with a conductive paste.

18. The method of manufacturing an electron emission device as claimed in claim 17, further comprising, after filling the spacer loading portions with a conductive paste, fitting the spacers into the spacer loading portions such that the spacers are electrically connected to the focusing electrode.
